(19) United States
(12) Patent Application Publication
(10) Pub. No.: US 2026/0341743 A1
(43) Pub. Date: Oct. 29, 2026

(54) SECONDARY BATTERY

(71) Applicant: Prime Planet Energy & Solutions, Inc., Tokyo (JP)

(72) Inventor: Shota YANASE, Kobe-shi (JP)

(21) Appl. No.: 19/654,464

(22) Filed: Apr. 22, 2026

(30) Foreign Application Priority Data
Apr. 28, 2025 (JP) 2025-074914

(51) Int. Cl. H01M 4/75; H01M 10/0525; H01M 10/0587; H01M 50/103; H01M 50/46

(52) U.S. Cl. CPC H01M 4/75; H01M 10/0525; H01M 10/0587; H01M 50/103; H01M 50/46

(57) ABSTRACT

A secondary battery disclosed herein includes a case, an electrode body, and an electrolytic solution. The case has a bottom wall, a first side wall, and a second side wall. The first side wall faces a cathode tab of the electrode body in the first direction and extends in a second direction. The second side wall faces an anode tab in the first direction and extends in the second direction. The bottom wall is connected to the bottom ends, in the second direction, of the first and second side walls. An aspect ratio of a length of the case in the first direction to a length of the case in the second direction is 2.0 or higher. When a virtual line passing through the bottom ends of the first and second side walls forms an inclination angle of 45° with respect to the horizontal direction, the electrolytic solution does not come into contact with the cathode and anode tab portions.

### CROSS REFERENCE TO RELATED APPLICATION

This application claims priority based on Japanese Patent Application No. 2025-074914 filed on Apr. 28, 2025, which is entirely incorporated herein by reference.

### BACKGROUND

The present disclosure relates to a secondary battery.

In recent years, rechargeable secondary batteries such as lithium ion secondary batteries have been used as portable power sources for mobile devices or the like and as vehicle drive power sources for electric vehicles (EV), hybrid electric vehicles (HEV), plug-in hybrid electric vehicles (PHEV), or the like. A secondary battery includes an assembly, as an electrode body, including electrodes (cathode, anode) responsible for a battery reaction during charging and discharging. The electrode body includes, for example, a laminated structure in which a cathode and an anode are alternately arranged via a separator. Such an electrode body includes a cathode tab portion electrically connected to multiple portions (multiple layers) of the cathode in the laminated structure, and an anode tab portion electrically connected to multiple portions (multiple layers) of the anode in the laminated structure. An electrode body is designed so that these tab portions are located on a lateral side of the electrode body (lateral side during normal battery use) in some cases (a lateral tab structure design). A secondary battery which is a nonaqueous electrolyte secondary battery including an electrode body having a lateral tab structure is described e.g. in Japanese Patent Application Laid-Open No. 2023-167298.

### SUMMARY

A high capacity has been required for secondary batteries. Particularly for secondary batteries used as vehicle drive power sources, a high capacity has been strongly required.

The present disclosure has been invented under the above circumstances, and an object of the present disclosure is to provide a secondary battery suitable for maintaining a battery performance while achieving a high capacity therefor.

The secondary battery disclosed herein includes an electrode body, a nonaqueous electrolytic solution, and a case for accommodating the electrode body and the nonaqueous electrolytic solution. The electrode body has a cathode tab portion on its one end and an anode tab portion on the other end in a first direction. The case has a bottom wall, a first side wall, and a second side wall. The first side wall faces the cathode tab portion in the first direction and extends in a second direction. The first direction and the second direction intersect each other. The second side wall faces the anode tab portion in the first direction and extends in the second direction. The bottom wall is connected to the bottom end, in the second direction, of the first side wall and the bottom end, in the second direction, of the second side wall. An aspect ratio of the first length of the case in the first direction to the second length of the case in the second direction is 2.0 or higher. When a virtual line passing through the bottom end of the first side wall and the bottom end of the second side wall forms an inclination angle of 45° with respect to the horizontal direction, the nonaqueous electrolytic solution in the case does not come into contact with the cathode tab portion and the anode tab portion.

In a secondary battery having such a configuration, the aspect ratio of 2.0 or higher is suitable for achieving a large volume for the case, and therefore for up-sizing the electrode body in the case and achieving a high capacity therefor. For suppressing components or impurities in the nonaqueous electrolytic solution from coming into contact with the electrode tab portions, it is suitable that the nonaqueous electrolytic solution in the case does not come into contact with the cathode tab portion and the anode tab portion while the secondary battery having the lateral tab structure as described above forms an inclination angle of 45° as described above (the contact of the nonaqueous electrolytic solution with the electrode tab portion is undesirable because the contact may cause deterioration in the electrode tab portion functionality or the battery performance). Thus, the secondary battery according to the present disclosure is suitable for maintaining the battery performance while achieving a high capacity therefor.

There is a tendency that the higher the aspect ratio, the higher a position that can be reached by the nonaqueous electrolytic solution surface (upper end surface) on a relatively lower side wall among the first and second side walls, during tilting of the secondary battery or the case. Secondary batteries having a lateral tab structure have a tendency that the higher the position that can be reached by the nonaqueous electrolytic solution surface during tilting, the more likely the nonaqueous electrolytic solution comes into contact the electrode tab portion. Although the contact of the nonaqueous electrolytic solution with the electrode tab portion can deteriorate the electrode tab portion functionality and consequently battery performance, the secondary battery according to the present disclosure is suitable for maintaining the battery performance because the secondary battery is configured such that the nonaqueous electrolytic solution does not come into contact with the electrode tab portion while the secondary battery forms an inclination angle of 45°.

### BRIEF DESCRIPTION OF THE DRAWINGS

FIG. 1 is a perspective view illustrating a secondary battery according to an embodiment of the present disclosure;

FIG. 2 is a schematic sectional view illustrating an internal structure of the secondary battery in FIG. 1;

FIG. 3 is a schematic sectional view of the secondary battery taken along line III-III in FIG. 2;

FIG. 4 is a schematic diagram illustrating a configuration of an electrode body provided in the secondary battery in FIG. 1.

FIG. 5 is a partially enlarged schematic diagram illustrating primarily one end portion of an anode and its vicinity in the electrode body.

FIG. 6 shows an example of the secondary battery in FIGS. 1 and 2 in a tilted state.

FIG. 7 shows another example of the secondary battery in FIGS. 1 and 2 in a tilted state.

### DETAILED DESCRIPTION

Embodiments of the secondary battery according to the present invention will be explained with reference to the drawings. Matters that are not specifically mentioned herein but necessary for implementing the present invention (e.g. general configuration and manufacturing process of a secondary battery that does not characterize the present invention) can be understood as matters designed by those skilled in the art on the basis of the prior art in the field. The present invention can be implemented based on the content disclosed herein and the common technical knowledge in the field. Furthermore, in the following drawings, members and portions having same effects are marked with same reference signs for explanation. The dimensional relationships (e.g. length, width, thickness) in each drawing do not necessarily reflect actual dimensional relationships.

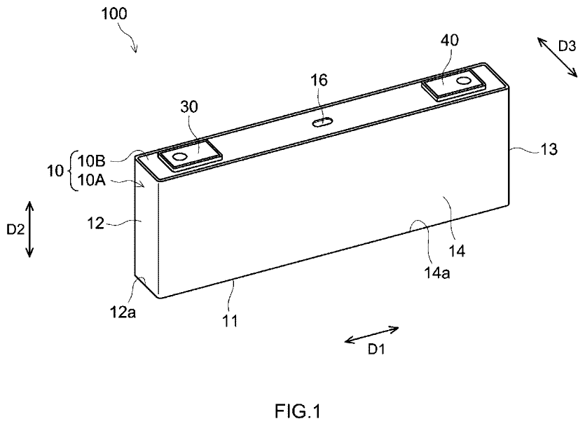

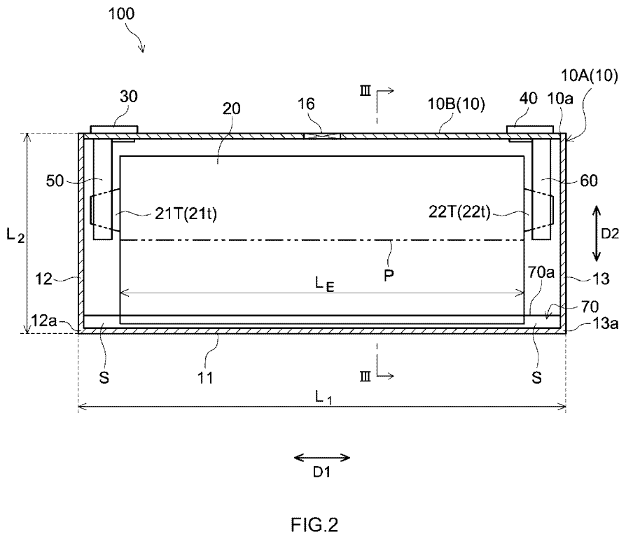

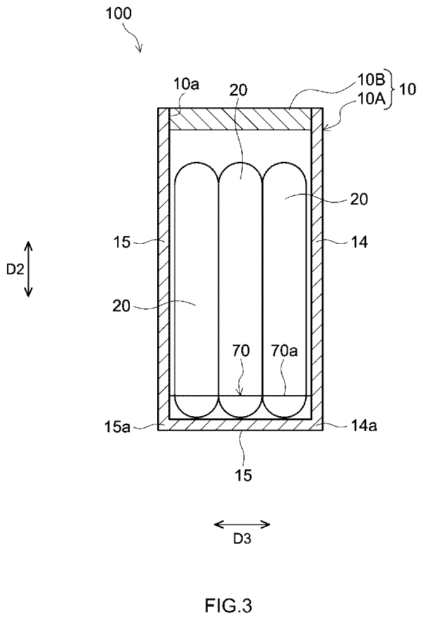

FIG. 1 is a perspective view illustrating a battery 100 as an embodiment of the secondary battery according to the present invention. FIG. 2 is a schematic sectional view illustrating an internal structure of the battery 100 in FIG. 1. FIG. 3 is a schematic sectional view of the battery 100 taken along line III-III in FIG. 2. As illustrated in FIG. 1 to FIG. 3, the battery 100 is a nonaqueous electrolyte secondary battery including a case 10, an electrode body 20 (electrode assembly), a cathode terminal 30 (positive terminal), an anode terminal 40 (negative terminal), a cathode current collection portion 50, an anode current collection portion 60, and an electrolytic solution 70 (nonaqueous electrolytic solution). In this embodiment, the battery 100 is a lithium ion secondary battery.

The case 10 is a housing for the battery 100 and accommodates the electrode body 20 and the electrolytic solution 70 as illustrated in FIG. 2. The case 10 includes a case body 10A and a sealing plate 10B. As illustrated in FIG. 1, the case 10 has a flat and almost rectangular parallelepiped (e.g. square) outer shape, extending in a first direction D1. In this embodiment, the case 10 has a height in a second direction D2 as one direction perpendicular to the first direction D1 and a thickness in a third direction D3 perpendicular to both the first direction D1 and the second direction D2.

The case body 10A has a flat and almost rectangular parallelepiped outer shape. In this embodiment, the case body 10A is a rectangular cylindrical bottomed case having an opening 10a (illustrated in FIGS. 2 and 3). Specifically, the case body 10A has a bottom wall 11, a pair of side walls 12 and 13 (narrow side walls), and a pair of side walls 14 and 15 (wide side walls). The side walls 12 and 13 as well as the side walls 14 and 15 constitute a peripheral side wall of the case body 10A. In the case body 10A, the bottom wall 11 is located on the lower end (end opposite to the opening 10a) in the second direction D2. The bottom wall 11 has a long side extending in the first direction D1 and a short side extending in the third direction D3, and has an almost rectangular shape extending in the first direction D1 and the third direction D3. The bottom wall 11 is preferably a flat plate-like wall (bottom wall), more preferably a flat rectangular plate-like wall (bottom wall). The side walls 12 and 13 each have a long side extending in the second direction D2 and a short side extending in the third direction D3, and have an almost rectangular shape extending in the second direction D2 and the third direction D3. The pair of side walls 12 and 13 face each other in the first direction D1. The side walls 14 and 15 each have a long side extending in the first direction D1 and a short side extending in the second direction D2, and have an almost rectangular shape extending in the first direction D1 and the second direction D2. The pair of side walls 14 and 15 face each other in the third direction D3. The lower ends, in the second direction D2, of the side walls 12 and 13 as well as side walls 14 and 15 in the second direction D2 are connected to the bottom wall 11. The end (bottom end) of each side wall (side walls 12, 13, 14, 15) on the bottom wall 11 side is located at a boundary between each side wall and the bottom wall 11 connected to each other, or at a midpoint in a boundary region (e.g. a corner or an R portion between each side wall and the bottom wall 11) between each side wall and the bottom wall 11 connected to each other. Specifically, in the case body 10A, the bottom wall 11 is connected to a bottom end 12a of the side wall 12, a bottom end 13a of the side wall 13, a bottom end 14a of the side wall 14, and a bottom end 15a of the side wall 15. This case body 10A is made of a metal. Examples of a constituent material for the case body 10A include aluminum, an aluminum alloy, iron, and an iron alloy. From the viewpoint of achieving both weight saving and a required rigidity for the case body 10A, the constituent material for the case body 10A is preferably aluminum or an aluminum alloy.

The sealing plate 10B is a member that closes the opening 10a of the case body 10A. The sealing plate 10B is welded to the edge of the opening 10a of the case body 10A over the entire circumference to close the opening 10a. In this embodiment, the sealing plate 10B is an almost rectangular flat plate-like member in plan view and has a shape capable of closing the opening 10a. Examples of a constituent material for the sealing plate 10B include aluminum, an aluminum alloy, an iron, and an iron alloy. From the viewpoint of the weight saving for the case 10, examples of the constituent material for the sealing plate 10B include aluminum and an aluminum alloy.

The case 10 includes a safety valve 16. In this embodiment, the safety valve 16 is located between the cathode terminal 30 and the anode terminal 40 on the sealing plate 10B (top surface) of the case 10. The safety valve 16 is a thin-walled portion configured to rupture when a gas pressure inside the case 10 rises above a predetermined value. When the safety valve 16 ruptures, the gas inside the case 10 is discharged outside the case 10 to prevent or suppress additional pressurization inside the case 10. In the case 10, the safety valve 16 may be provided on the case body 10A instead of on the sealing plate 10B.

The case 10 has an injection hole (not illustrated) for injecting the electrolytic solution 70 into the case 10. The injection hole is located e.g. between the cathode terminal 30 and the safety valve 16 on the sealing plate 10B (top surface) of the case 10. In the case 10, the injection hole may be provided on the case body 10A instead of on the sealing plate 10B. The injection hole is sealed by a sealing member after injection of the electrolytic solution 70.

As illustrated in FIG. 2, the case 10 has a length L₁ (first length) in the first direction D1 and a length L₂ (second length) in the second direction D2. An aspect ratio (L₁/L₂) of the length L₁ to the length L₂ is 2.0 or higher, preferably 2.5 or higher, more preferably 2.8 or higher. This configuration is preferable for achieving a large volume for the case 10, and therefore preferable for up-sizing the electrode bodies 20 in the case 10 and increasing the capacity. The aspect ratio (L₁/L₂) is preferably 4.0 or lower, more preferably 3.5 or lower. This configuration helps to avoid the contact between the electrolytic solution 70 and a cathode tab portion 21T and anode tab portion 22T described later, and therefore is preferable for suppressing the contact between components or impurities in the electrolytic solution 70 and the cathode tab portion 21T and anode tab portion 22T (in the nonaqueous electrolyte secondary battery having a lateral tab structure, the higher the aspect ratio of the battery case, the higher the position that can be reached by the electrolytic solution surface on a relatively lower side wall during tilting, and thus, the electrolytic solution tends to come into contact with the electrode tab portion).

In this embodiment, the case 10 described above accommodates multiple electrode bodies 20. That is, in this embodiment, the battery 100 includes multiple electrode bodies 20. As illustrated in FIG. 3, the multiple electrode bodies 20 are laminated in the third direction D3 (FIG. 3 illustrates a case where three electrode bodies 20 are stacked). This configuration is preferable from the viewpoint of reducing dead spaces in the case 10 and helps to achieve a high volumetric energy density of the battery 100. Reduction of the dead spaces in the case 10 also helps to reduce an extra amount of the electrolytic solution 70, described later.

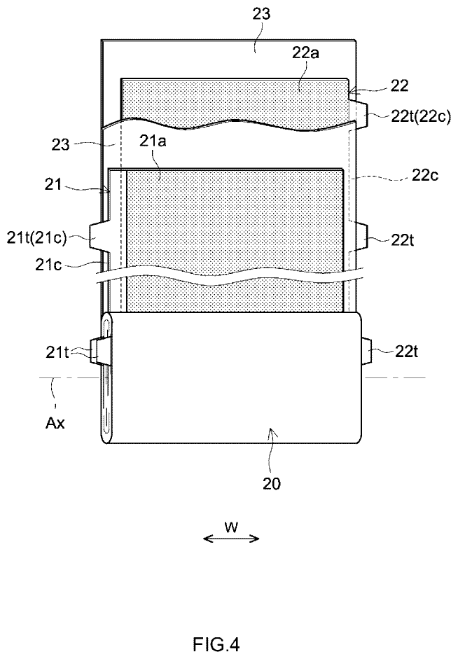

FIG. 4 is a schematic diagram illustrating a configuration of each electrode body 20. The electrode body 20 includes a laminated structure with a cathode 21 (positive electrode) and an anode 22 (negative electrode) alternately arranged via a separator 23. In this embodiment, the electrode body 20 is a wound electrode body having the strip-like cathode 21, the strip-like anode 22, and the strip-like separator 23, with the cathode 21 and the anode 22 wound via the separator 23 in the longitudinal direction. Specifically, the electrode body 20 is a flat wound electrode body, which is formed by winding an elongated sheet-like laminate (having a width perpendicular to its longitudinal direction) with the elongated sheet-like cathode 21, the elongated sheet-like separator 23, the elongated sheet-like anode 22, and an additional elongated sheet-like separator 23 arranged in this order. After winding, the wound electrode body may be flattened by being pressed in the thickness direction (wound electrode body pressing step). The electrode body 20 has a flat shape in the third direction D3 (e.g. illustrated in FIG. 3). The third direction D3 intersects (in this embodiment, orthogonal to) the first direction D1 and the second direction D2. This electrode body 20 (wound electrode body) is accommodated in the case 10 (see FIG. 2) with its winding axis Ax oriented along the first direction D1. Instead of this configuration, the electrode body 20 may be a laminated electrode body in which a quadrate cathode and a quadrate anode are laminated in a state insulated from each other.

The cathode 21 has a laminated structure including a cathode current collector 21c and a cathode active material layer 21a (positive active material layer). In this embodiment, the cathode 21 has the cathode active material layers 21a on both sides of the cathode current collector 21c. Examples of the cathode current collector 21c include a conductive metal foil and a resin sheet with a double-sided conductive metal layer. Examples of the conductive metal for the cathode current collector 21c include aluminum, an aluminum alloy, nickel, titanium, and stainless steel. Above all, aluminum is preferable. The cathode active material layer 21a contains a cathode active material (positive active material) capable of reversibly storing and releasing charge carriers. The cathode active material is preferably a lithium transition metal composite oxide. Specific examples of this oxide include a lithium-cobalt composite oxide, a lithium-manganese composite oxide, a lithium-nickel composite oxide, a lithium-nickel-manganese composite oxide, a lithium-nickel-cobalt composite oxide, and a lithium-nickel-cobalt-manganese composite oxide. The cathode active material layer 21a may contain additives other than the cathode active material. Examples of the additives include a conductive material, a binder, and trilithium phosphate. Examples of the conductive material include acetylene black, Ketjen black, graphite, and carbon nanotube. Examples of the binder include a fluororesin such as polyvinylidene fluoride (PVDF) and a rubber material such as styrene-butadiene rubber (SBR).

The cathode current collector 21c has multiple tabs 21t on one end (left end in FIG. 4) of the electrode body 20 or cathode 21 in the width direction W. The width direction W refers to a direction perpendicular to the longitudinal direction of the elongated sheet-like laminate. In the cathode current collector 21c, the tabs 21t are included in an exposed region where the cathode active material layer 21a is not laminated. In the wound electrode body 20, the multiple tabs 21t are stacked in the laminating direction of the laminated structure of the electrode body 20 to form the cathode tab portion 21T (illustrated in FIG. 2) (in the cathode current collector 21c, the tabs 21t are provided in that arrangement). The cathode tab portion 21T functionally serves as the current collection portion in the cathode 21. In this integrally stacked state, the tabs 21t are connected to the cathode current collection portion 50 (cathode current collection portion 50 is provided on each cathode tab portion 21T). Examples of a constituent material for the cathode current collection portion 50 include aluminum and an aluminum alloy. Examples of the method for connecting the cathode current collection portions 50 to the cathode tab portion 21T in the cathode 21 include ultrasonic joining and laser welding.

The anode 22 has a laminated structure including an anode current collector 22c and an anode active material layer 22a (negative active material layer). In this embodiment, the anode 22 has the anode active material layers 22a on both sides of the anode current collector 22c. Examples of the anode current collector 22c include a conductive metal foil and a resin sheet with a double-sided conductive metal layer. Examples of the conductive metal for the anode current collector 22c include copper, a copper alloy, nickel, and stainless steel, and a copper foil is preferable. The anode active material layer 22a contains an anode active material (negative active material) capable of reversibly storing and releasing charge carriers. Examples of the anode active material include a carbon material such as graphite, hard carbon, and soft carbon. The graphite may be natural graphite or artificial graphite. The anode active material layers 22a may contain additives other than the anode active material. Examples of the additives include a binder and a thickener. Examples of the binder include a rubber material such as styrene-butadiene rubber (SBR) and a fluororesin such as polyvinylidene fluoride (PVDF). Example of the thickener includes a cellulose material such as carboxymethylcellulose (CMC).

The anode current collector 22c has multiple tabs 22t on the other end (right end in the figure) of the electrode body 20 or the anode 22 in the width direction W. In the anode current collector 22c, the tabs 22t are included in an exposed region where the anode active material layer 22a is not laminated. In the electrode body 20 that is a wound electrode body, the multiple tabs 22t are laminated in the laminating direction of the laminated structure of the electrode body 20 to form the anode tab portion 22T (illustrated in FIG. 2) (in the anode current collector 22c, the tabs 22t are provided in that arrangement). The anode tab portion 22T functionally serves as the current collection portion in the anode 22. In this integrally stacked state, the tabs 22t are connected to the anode current collection portion 60 (anode current collection portion 60 is provided on each anode tab portion 22T). Examples of a constituent material for the anode current collection portions 60 include copper and a copper alloy. Examples of the method for connecting the anode current collection portions 60 to the anode tab portions 22T in the anode 22 include ultrasonic joining and laser welding.

The separator 23 is intended to insulate between the cathode 21 or the cathode active material layer 21a and the anode 22 or the anode active material layer 22a while retaining an ion-conductive electrolytic solution between the two layers. A porous resin sheet made of a polyolefin resin is preferable as the separator 23. Examples of the polyolefin resin include polyethylene (PE) and polypropylene (PP). A heat resistance layer (HRL) containing an inorganic filler may be provided on the surface of the separator 23. Examples of a constituent material for the inorganic filler include alumina, boehmite, aluminum hydroxide, and titania.

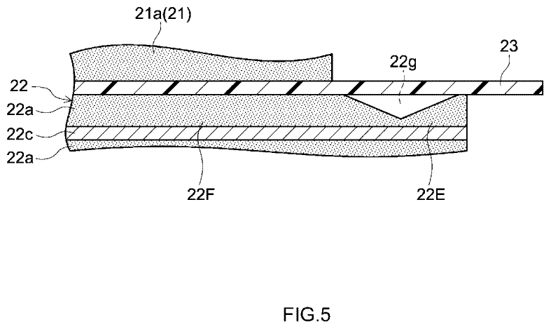

FIG. 5 is a partially enlarged schematic diagram illustrating primarily one end portion of the anode 22 and its vicinity in the electrode body 20. As illustrated in FIG. 5, the anode 22 includes a facing portion 22F and non-facing edge portion 22E. The anode 22 has the non-facing edge portion 22E on both ends in the width direction W. The facing portion 22F is a region that faces the cathode 21 via the separator 23 in the anode 22. The non-facing edge portion 22E is a region that does not face the cathode 21 via the separator 23. The anode active material layer 22a of this anode 22 has a groove portion 22g. The groove portion 22g is a portion where the surface of the anode active material layer 22a is regressed from the separator 23 on a boundary region between the facing portion 22F and the non-facing edge portion 22E or on the non-facing edge portion 22E. The groove portion 22g may be provided over the entire longitudinal direction of the anode active material layer 22a or only on a part thereof. A ratio of the depth of the groove portion 22g to the thickness of the anode active material layer 22a is preferably 0.3 or higher, more preferably 0.5 or higher, even more preferably 0.7 or higher, and preferably 0.95 or lower, more preferably 0.85 or lower, further preferably 0.80 or lower. This configuration is preferable for the groove portion 22g to effectively function as a storage space for the electrolytic solution 70. The depth of the groove portion 22g refers to the length (dimension) between the opening end and the deepest portion of the groove portion 22g in the thickness direction of the anode active material layer 22a. Such a groove portion 22g can be formed e.g. by adjusting the pressing pressure during the aforementioned winding electrode body pressing step in the manufacturing process for the electrode body 20.

As illustrated in FIG. 2, each electrode body 20 with the above configuration has the cathode tab portion 21T on its one end and an anode tab portion 22T on the other end in the first direction D1 in the case 10. The side wall 12 of the case 10 or case body 10A faces the cathode tab portion 21T in the first direction D1 and extends in the second direction D2. The side wall 13 faces the anode tab portion 22T in the first direction D1 and extends in the second direction D2. Furthermore, the cathode tab portion 21T and the anode tab portion 22T are each located on the side opposite to the bottom wall 11 with respect to the middle position P of the electrode body 20 in the second direction D2. This configuration helps to avoid the electrolytic solution 70 from coming into contact with the cathode tab portion 21T and anode tab portion 22T, and is preferable for suppressing components or impurities in the electrolytic solution 70 from coming into contact with the cathode tab portion 21T and anode tab portion 22T.

The cathode terminal 30 is attached to the sealing plate 10B, as illustrated in FIGS. 1 and 2. For example, the sealing plate 10B has an opening for the terminal, which penetrates the sealing plate 10B in the thickness direction, and the cathode terminal 30 is attached to the opening, with an insulative gasket interposed between the cathode terminal 30 and the sealing plate 10B. A method for attaching the cathode terminal 30 to the sealing plate 10B can be exemplified by caulking (the same applies to the method for attaching the anode terminal 40 described later). The cathode terminal 30 is exposed to the outside and inside of the case 10. Inside the case 10, the cathode terminal 30 is connected to the cathode current collection portion 50. The connection method can be exemplified by laser welding. This cathode terminal 30 is preferably made of aluminum or an aluminum alloy.

The anode terminal 40 is attached to the sealing plate 10B. The anode terminal 40 is exposed to the outside and inside of the case 10. Inside the case 10, the anode terminal 40 is connected to the anode current collection portion 60. The connection method can be exemplified by laser welding. This anode terminal 40 is preferably made of copper or a copper alloy.

The electrolytic solution 70 is accommodated in the case 10 together with the electrode body 20. The electrolytic solution 70 permeates the electrode body 20. The electrolytic solution 70 is a nonaqueous electrolytic solution containing a nonaqueous solvent and an electrolyte (supporting salt). Examples of the nonaqueous solvent include ethylene carbonate (EC), dimethyl carbonate (DMC), and ethyl methyl carbonate (EMC). Example of the electrolyte includes a fluorine-containing lithium salt. Examples of the fluorine-containing lithium salt include lithium hexafluorophosphate (LiPF₆) and lithium bis(fluorosulfonyl)imide (LiN(SO₂F)₂). Extra electrolytic solution 70 not permeating the electrode body 20 is also stored in the case 10.

A ratio (liquid injection ratio) of the amount of electrolytic solution 70 injected into the case 10 to the total void volume of the multiple layers constituting electrode body 20 is preferably 1.10 or higher, more preferably 1.15 or higher, even more preferably 1.20 or higher. This configuration is preferable for preventing the electrolytic solution 70 from insufficiently permeating the electrode body 20. The liquid injection ratio is preferably 1.40 or lower, more preferably 1.30 or lower, even more preferably 1.25 or lower. Such an upper limit of the electrolytic solution 70 amount helps to avoid the electrolytic solution 70 from coming into contact with the cathode tab portion 21T and anode tab portion 22T, and is therefore preferable for suppressing components or impurities in the electrolytic solution 70 from coming into contact with the cathode tab portion 21T and anode tab portion 22T. The voids in the layers constituting the electrode body 20 refer to voids which can be permeated with the electrolytic solution 70 from the outside of the electrode body 20. In this embodiment, the void volume of the multiple layers constituting the electrode body 20 includes the void volume of the cathode active material layer 21a, the void volume of the anode active material layer 22a, and the void volume of the separator 23. A void volume of a layer can be calculated by a product of an area, a thickness, and a porosity of the layer. A porosity of a layer can be calculated e.g. based on an actual volume of the layer measured by a mercury penetration porosimeter, and a theoretical volume of the layer calculated from the battery materials.

An amount of the electrolytic solution 70 per an energy density (Wh/L) in the battery 100 is preferably 0.80 g·L/Wh or less, more preferably 0.75 g·L/Wh or less, even more preferably 0.70 g·L/Wh or less. Keeping the electrolytic solution 70 amount to this level helps to avoid the electrolytic solution 70 from coming into contact with the cathode tab portion 21T and anode tab portion 22T, and is therefore preferable for suppressing components or impurities in the electrolytic solution 70 from coming into contact with the cathode tab portion 21T and anode tab portion 22T.

In the battery 100, a ratio (L₁/L_{E}) of the length L₁ of the case 10 to a length L_{E} of the electrode body 20 in the first direction D1 (illustrated in FIG. 2) is preferably 1.010 or higher, more preferably 1.030 or higher, even more preferably 1.050 or higher. This configuration is preferable for ensuring, in the case 10, a space S (illustrated in FIG. 2) that stores extra electrolytic solution 70 not permeating the electrode body 20. The ratio (L₁/L_{E}) is preferably 1.100 or lower, more preferably 1.070 or lower, even more preferably 1.055 or lower. This configuration is preferable from the viewpoint of reducing the extra amount of electrolytic solution 70. Reduction of the extra electrolytic solution 70 helps to avoid the electrolytic solution 70 from coming into contact with the electrode tab portions (cathode tab portion 21T, anode tab portion 22T) when the battery is tilted (the more the extra amount, the closer the liquid surface 70a of the electrolytic solution 70 to the electrode tab portion during tilting of the battery).

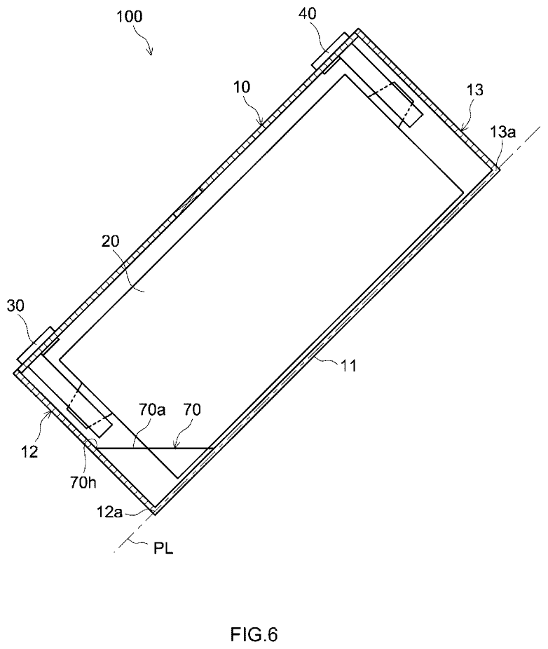

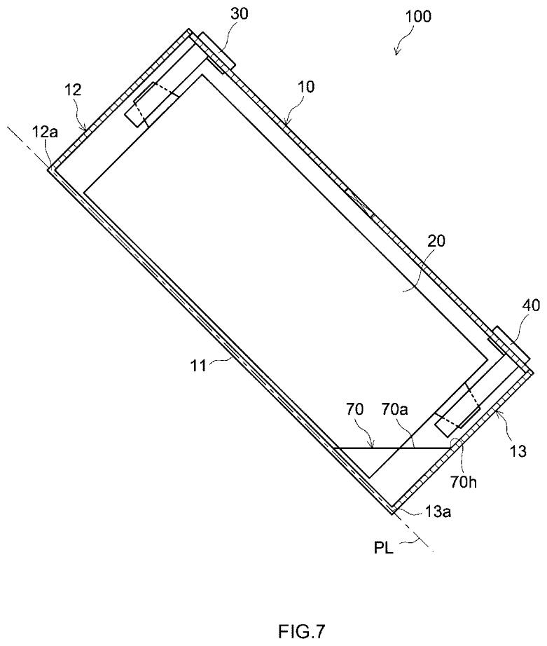

FIGS. 6 and 7 show an example of the battery 100 tilted. FIG. 6 shows a state that a virtual line PL passing through the bottom end 12a of the side wall 12 and the bottom end 13a of the side wall 13 in the case 10 of the battery 100 forms an inclination angle of 45° with respect to the horizontal direction, with the side wall 12 located relatively lower than the side wall 13 (first tilting state). FIG. 7 shows a state that the virtual line PL forms an inclination angle of 45° with respect to the horizontal direction, with the side wall 13 located relatively lower than the side wall 12 (second tilting state). As illustrated in FIGS. 6 and 7, when the bottom wall 11 is flat, the virtual line PL passing through the bottom ends 12a and 13a of the side walls 12 and 13 also passes through the flat plate-like bottom wall 11. When the boundary region between the side walls 12 and 13 and bottom wall 11 connected to each other is an R portion, the bottom ends 12a and 13a of the side walls 12 and 13 are located at the midpoint of the boundary region as described above, and the virtual line PL passes through such bottom ends 12a and 13a. Furthermore, the battery 100 is configured such that, in both the first and second tilting states, the electrolytic solution 70 in the case 10 does not come into contact with the cathode tab portion 21T and anode tab portion 22T. Preferably, the battery 100 is configured such that the bottom wall 11 is flat, and the electrolytic solution 70 in the case 10 does not come into contact with the cathode tab portion 21T and anode tab portion 22T in a state that the virtual line PL passing through the bottom wall 11 and the bottom ends 12a and 13a and extending in the first direction D1 forms an inclination angle of 45° with respect to the horizontal direction. In this case, more preferably, the bottom wall 11 has a rectangular flat plate shape. Furthermore, although the amount of the electrolytic solution 70 outside of the electrode body 20 in the case 10 changes depending on charging and discharging of the battery 100, the battery 100 is configured such that the electrolytic solution 70 does not come into contact with the cathode tab portion 21T and anode tab portion 22T even when the amount of the electrolytic solution changes in this manner.

In the battery 100 having the above configuration, for achieving a large volume for the case 10 as described above, it is suitable that the aspect ratio of the length L₁ to the length L₂ of the case 10 (L₁/L₂) is 2.0 or higher. Thus, the aspect is suitable for up-sizing the electrode body 20 in the case 10 and achieving a high capacity therefor. Furthermore, in the battery 100 with a lateral tab structure, for preventing components and impurities in the electrolytic solution 70 from coming into contact with the cathode tab portion 21T and anode tab portion 22T, it is suitable that the electrolytic solution 70 in the case 10 does not come into contact with the cathode tab portion 21T and anode tab portion 22T in a state that the virtual line PL forms an inclination angle of 45° with respect to the horizontal direction (first tilted state, second tilted state). For example, when the battery 100 is mounted as a vehicle drive power source in a vehicle, the configuration is suitable for suppressing components and impurities in the electrolytic solution 70 from coming into contact with the cathode tab portion 21T and anode tab portion 22T even while the vehicle is driven not only on a flat road or parked but also on a sloping road or a rough ground. Thus, the battery 100 is suitable for maintaining the battery performance while achieving a high capacity therefor.

There is a tendency that the higher the aspect ratio (L₁/L₂), the higher a position 70h that can be reached by the liquid surface 70a (upper end surface) of the electrolytic solution 70 on a relatively lower side wall (side walls 12 and 13) among the side walls 12 and 13 during tilting of the battery 100 or the case 10. In the nonaqueous electrolyte secondary battery with the lateral tab structure, the higher the position that can be reached by the liquid surface of the electrolytic solution during tilting, the more likely the electrolytic solution comes into contact the electrode tab portion. The contact of the electrolytic solution with the electrode tab portion is undesirable because the contact may deteriorate the electrode tab portion functionality and consequently battery performance. In contrast, the battery 100 is suitable for maintaining the battery performance, because it is configured such that the electrolytic solution 70 does not come into contact with the cathode tab portion 21T and anode tab portion 22T in the first and second tilted states described above.

The battery 100 can be used for various applications. For example, the battery 100 can be suitably used as a power source (drive power source) for motors mounted in vehicles such as passenger vehicles and trucks. Examples of the vehicle type include, but are not limited to, plug-in hybrid electric vehicles (PHEV), hybrid electric vehicles (HEV), and battery electric vehicles (BEV).

Furthermore, the battery disclosed herein may be any power storage device other than lithium ion batteries. Examples of the power storage device include not only batteries commonly referred to as lithium ion batteries or lithium secondary batteries but also batteries such as nickel-metal hydride batteries. In this specification, the term “power storage device” refers to any general rechargeable device.

As described above, the technology disclosed herein has been variously explained. Unless specifically stated otherwise, the embodiments described herein do not limit the present invention. Furthermore, the technology disclosed herein may be variously modified. Unless particular problems arise, each component and each process mentioned herein may be omitted or combined with each other as appropriate. The present specification includes disclosures described in each item below.

### Item 1:

A secondary battery including:
an electrode body, a nonaqueous electrolytic solution, and a case for accommodating the electrode body and the nonaqueous electrolytic solution, in which
the electrode body has a cathode tab portion on its one end and an anode tab portion on the other end in a first direction,
the case has a first side wall, a second side wall, and a bottom wall,
the first side wall faces the cathode tab portion in the first direction and extends in a second direction intersecting the first direction,
the second side wall faces the anode tab portion in the first direction and extends in the second direction,
the bottom wall is connected to a bottom end, in the second direction, of the first side wall and a bottom end, in the second direction, of the second side wall,
an aspect ratio of a first length of the case in the first direction to a second length of the case in the second direction is 2.0 or higher, and
when a virtual line passing through the bottom end of the first side wall and the bottom end of the second side wall forms an inclination angle of 45° with respect to the horizontal direction, the nonaqueous electrolytic solution does not come into contact with the cathode tab portion and the anode tab portion in the case.

### Item 2:

The secondary battery according to Item 1, in which the aspect ratio is 4.0 or lower.

### Item 3:

The secondary battery according to Item 1 or 2, in which an amount of the nonaqueous electrolytic solution per an energy density (Wh/L) is 0.80 g·L/Wh or less.

### Item 4:

The secondary battery according to any one of Items 1 to 3, in which a ratio of the first length of the case to a length of the electrode body in the first direction is 1.100 or lower.

### Item 5:

The secondary battery according to any one of Items 1 to 4, in which the cathode tab portion and the anode tab portion are each located on a side opposite to the bottom wall with respect to a middle position of the electrode body in the second direction.

### Item 6:

The secondary battery according to any one of Items 1 to 5, in which the electrode body is a wound electrode body having a strip-like cathode, a strip-like anode, and a strip-like separator with the cathode and the anode longitudinally wound via the separator, and has a flat shape in a third direction intersecting the first direction and the second direction.

### Item 7:

The secondary battery according to Item 6, in which
the anode has a laminated structure including an anode current collector and an anode active material layer, and includes a facing portion that faces the cathode via the separator and a non-facing edge portion that does not face the cathode via the separator, and
the anode active material layer has a groove portion where the surface of the anode active material layer is regressed from the separator on a boundary region between the facing portion and the non-facing edge portion or on the non-facing edge portion.

### Item 8:

The secondary battery according to Item 6 or 7, in which the electrode body includes a plurality of wound electrode bodies, and the plurality of wound electrode bodies are stacked in the third direction in the case.

### Item 9:

The secondary battery according to any one of Items 1 to 8, in which a ratio of a nonaqueous electrolytic solution amount to a total void volume of a plurality of layers constituting the electrode body is 1.10 or higher.

What is claimed is:

1. A secondary battery comprising
an electrode body, a nonaqueous electrolytic solution, and a case for accommodating the electrode body and the nonaqueous electrolytic solution, wherein
the electrode body has a cathode tab portion on its one end and an anode tab portion on the other end in a first direction,
the case has a bottom wall, a first side wall, and a second side wall,
the first side wall faces the cathode tab portion in the first direction and extends in a second direction intersecting the first direction,
the second side wall faces the anode tab portion in the first direction and extends in the second direction,
the bottom wall is connected to a bottom end, in the second direction, of the first side wall and a bottom end, in the second direction, of the second side wall,
an aspect ratio of a first length of the case in the first direction to a second length of the case in the second direction is 2.0 or higher, and
when a virtual line passing through the bottom end of the first side wall and the bottom end of the second side wall forms an inclination angle of 45° with respect to the horizontal direction, the nonaqueous electrolytic solution in the case does not come into contact with the cathode tab portion and the anode tab portion.

2. The secondary battery according to claim 1, wherein the aspect ratio is 4.0 or lower.

3. The secondary battery according to claim 1, wherein an amount of the nonaqueous electrolytic solution per an energy density (Wh/L) is 0.80 g·L/Wh or less.

4. The secondary battery according to claim 1, wherein a ratio of the first length of the case to a length of the electrode body in the first direction is 1.100 or lower.

5. The secondary battery according to claim 1, wherein the cathode tab portion and the anode tab portion are each located on a side opposite to the bottom wall with respect to a middle position of the electrode body in the second direction.

6. The secondary battery according to claim 1, wherein the electrode body is a wound electrode body having a strip-like cathode, a strip-like anode, and a strip-like separator with the cathode and the anode longitudinally wound via the separator, and has a flat shape in a third direction intersecting the first direction and the second direction.

7. The secondary battery according to claim 6, wherein
the anode has a laminated structure including an anode current collector and an anode active material layer, and includes a facing portion that faces the cathode via the separator and a non-facing edge portion that does not face the cathode via the separator, and
the anode active material layer has a groove portion where the surface of the anode active material layer is regressed from the separator on a boundary region between the facing portion and the non-facing edge portion or on the non-facing edge portion.

8. The secondary battery according to claim 6, wherein the electrode body includes a plurality of wound electrode bodies, and the plurality of wound electrode bodies are stacked in the third direction in the case.

9. The secondary battery according to claim 1, wherein a ratio of a nonaqueous electrolytic solution amount to a total void volume of a plurality of layers constituting the electrode body is 1.10 or higher.
